(19) United States
(12) Patent Application Publication
(10) Pub. No.: US 2008/0151317 A1
(43) Pub. Date: Jun. 26, 2008

(54) IMAGE PROCESSING APPARATUS, IMAGE PROCESSING METHOD, PROGRAM PRODUCT, AND STORAGE MEDIUM

(75) Inventor: Ryotaro Imine, Machida-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/843,149

(22) Filed: Aug. 22, 2007

(30) Foreign Application Priority Data
Dec. 20, 2006 (JP) 2006-343047

(51) Int. Cl. H04N 1/00

(52) U.S. Cl. 358/403

(57) ABSTRACT

Moving image data that includes a plurality of frames is input, and a frame is selected from the plurality of frames included in the input moving image data. The selected frame is extracted as still image data, and location information is added to the extracted still image data as attribute information and stored in a memory unit, the location information indicating a location of the selected frame in the moving image data. Further, a plurality of still image data stored in the memory unit is selected and printed according to an order determined based on the location information.

### BACKGROUND OF THE INVENTION

1. Field of the Invention

The present invention relates to an image processing apparatus (e.g., printing apparatus, multi-function peripheral (MFP)), an image processing method, and a storage medium, and, more specifically, to extracting frames from moving image data as still image data and processing the still image data.

2. Description of the Related Art

In recent years, moving image contents can be easily processed as an Internet communication speed and a memory capacity of an information processing apparatus have been increased. In addition, a user can easily take moving images with a digital camera or digital camcoder. Examples of the moving image data include TV program or movie contents, or scenes of a daily life captured by a user.

In this regard, one scene can be selected from the above-described moving image data, and extracted and used as still image data. For example, a scene where a recipe is introduced in a cooking program can be extracted and stored as still image data, and then displayed or printed. Further, a selected scene can be extracted as still image data from moving image data captured by a user while traveling, and the extracted image can be developed to a photograph.

For example, Japanese Patent Application Laid-Open No. 2006-060649 discusses a technique of dividing moving image data into a predetermined number of sections, and extracting and displaying still images corresponding to a predetermined number of frame images belonging to each section to print still images selected by a user.

When a plurality of still image data is extracted by the above-described method or the like, there is a demand to rearrange still image data in the order of reproduction in the moving image data. More specifically, a user may wish to use the extracted still image data to create a table of contents of moving image data, or to extract still image data from moving image data captured by the user while traveling in order to create an album.

However, in the case of extracting still image data from moving image data by the above conventional method, the extracted still image data is stored in independent files. That is, there is no information that associates these still image data with each other, therefore, a plurality of still image data that is stored later cannot be rearranged in the order of reproduction in the moving image data.

Further, in the case of generating still image data, the still image data can be generally given a file name such as 0001, 0002, 0003, . . . , in the order in which the still images are generated. If such a file name can be given even at the time of extracting still image data from moving image data, a plurality of still image data can be rearranged in the order in which the images are extracted.

However, in the case of extracting a desired scene as still image data on fast forward or fast reverse, a sequence of extracted images does not always correspond to a sequence of reproduction. That is, even if still image data are rearranged in accordance with the file name that indicates the order of generation, the still images may not be arranged in the order of reproduction of the moving image data.

### SUMMARY OF THE INVENTION

Embodiments of the present invention is directed to an image processing apparatus, an image processing method, a program product, and a storage medium for extracting a frame in moving image data as still image data while adding information about a location of the frame in the moving image data.

According to an aspect of the present invention, an image processing apparatus includes: an input unit configured to input moving image data that includes a plurality of frames; a first selecting unit configured to select a frame from the plurality of frames included in the input moving image data; an extraction unit configured to extract the frame selected by the first selection unit from the moving image data as still image data; an adding unit configured to add location information to the extracted still image data as attribute information, the location information indicating a location of the selected frame in the moving image data; a memory unit configured to store the extracted still image data to which the location information is added; a second selecting unit configured to select a plurality of still image data stored in the memory unit; and a printing unit configured to print the plurality of still image data selected by the second selecting unit according to an order determined based on the location information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram of a multi functional peripheral (MFP) according to an exemplary embodiment of the present invention.

FIG. 2 illustrates an appearance of an operation unit according to the exemplary embodiment of the present invention.

FIG. 3 illustrates a basic COPY screen displayed on the operation unit according to the exemplary embodiment of the present invention.

FIG. 4 illustrates a file list screen displayed on the operation unit according to the exemplary embodiment of the present invention.

FIG. 5 is a schematic diagram illustrating a structure of moving image data stored in a hard disk drive (HDD) according to the exemplary embodiment of the present invention.

FIG. 6 illustrates time code information according to the exemplary embodiment of the present invention.

FIG. 7 illustrates a capture instructing screen displayed on the operation unit according to the exemplary embodiment of the present invention.

FIG. 8 is a flowchart of an operation of extracting still image data according to the exemplary embodiment of the present invention.

FIG. 9 illustrates a file list screen displayed on the operation unit according to the exemplary embodiment of the present invention.

FIG. 10 illustrates a printing condition setting screen displayed on the operation unit according to the exemplary embodiment of the present invention.

FIG. 11 is a flowchart of an operation for printing still image data according to the exemplary embodiment of the present invention.

FIG. 12 illustrates a file list screen displayed on the operation unit according to the exemplary embodiment of the present invention.

FIG. 13 illustrates a property display screen displayed on the operation unit according to the exemplary embodiment of the present invention.

FIG. 14 illustrates a processing of rearranging files according to the exemplary embodiment of the present invention.

### DETAILED DESCRIPTION OF THE EMBODIMENTS

Various exemplary embodiments, features, and aspects of the invention will be described in detail below with reference to the drawings.

Hereinafter, exemplary embodiments of the present invention will be described.

### First Exemplary Embodiment

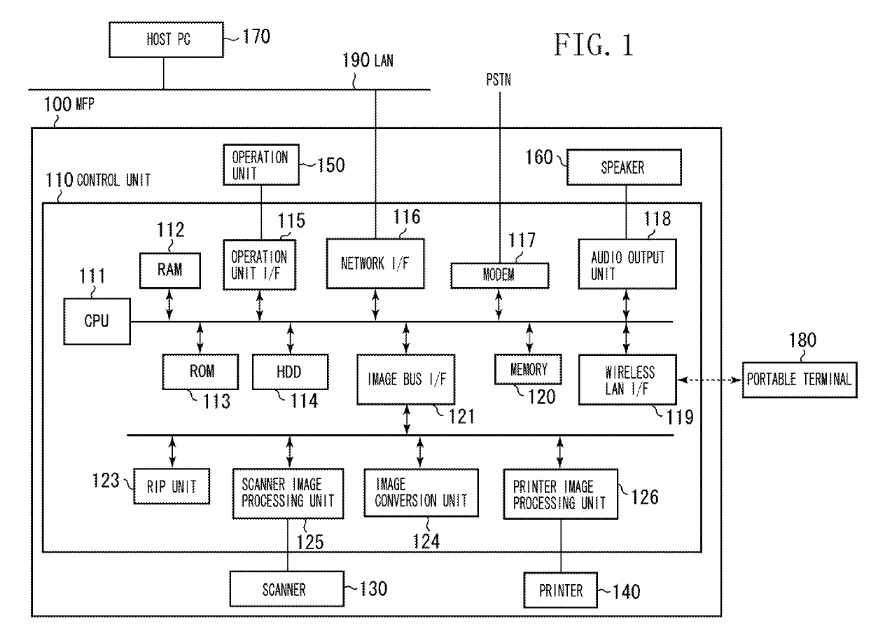

FIG. 1 is a block diagram of a multi-function peripheral (MFP) 100 serving as an image processing apparatus according to the present invention.

A control unit 110 is connected to a printer 140 (i.e., an image output device) and a scanner 130 (i.e., an image input device), and controls input/output of image information. On the other hand, the control unit 110 is connected to a local area network (LAN) 190 or Public Switched Telephone Networks (PSTN) (i.e., public line) and controls input/output of image information including moving image data or still image data, or device information.

A central processing unit (CPU) 111 controls the MFP 100 and operates in accordance with programs stored in a random access memory (RAM) 112. The RAM 112 serves as an image memory for temporarily storing image data. A read-only memory (ROM) 113 is a boot ROM and stores a boot program for a system. A hard disk drive HDD 114 stores system software, image data, and programs for controlling operations of the MFP 100. The programs stored in the HDD 114 are loaded onto the RAM 112, and the CPU 111 controls operations of the MFP 100 based on the programs.

An operation unit interface (I/F) 115 connects the operation unit 150 to the control unit 110 to output image data to the operation unit 150 on which the image data is displayed. Further, the I/F 115 transmits information input by a user via the operation unit 150 to the CPU 111. A network I/F 116 is connected to the LAN 190 and controls input/output of various types of information. A Modem 117 is connected to the PSTN and controls input/output of image information.

An audio output unit 118 outputs audio information to a speaker 160 when moving image data or audio data stored in the HDD 114 is reproduced. A wireless LAN I/F 119 performs wireless communications such as infrared communications to transmit/receive moving image data or still image data to/from a portable terminal 180 such as a cell phone, a notebook computer, or a digital camera. Moving image data or still image data received through the wireless LAN I/F 119 is stored in a user box in the HDD 114 as described below. A memory 120 stores moving image data or still image data, similar to the HDD 114. The memory 120 can be a removable external storage device.

An ImageBus I/F 121 controls high-speed input/output of image data through ImageBus. A raster image processor (RIP) unit 123 expands a page description language (PDL) code received from a host PC 170 through the LAN 190 and the network I/F 116, into a bit map image.

A scanner image processing unit 125 performs image correction on image data read from the original by the scanner 130. The printer image processing unit 126 performs image correction on image data output to the printer 140.

An image conversion unit 124 performs image conversion on image data stored in the RAM 112. More specifically, the image conversion unit 124 performs processing such as image rotation or resolution conversion on an image. Moreover, the image conversion unit 124 converts a binary image to a multilevel image, or a multilevel image to a binary image.

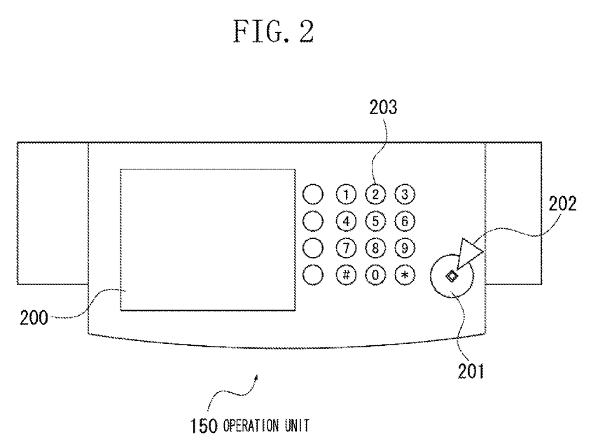

FIG. 2 shows an appearance of the operation unit 150 of the MFP 100. A liquid crystal panel 200 is a liquid crystal display device with a touch panel sheet, and displays an operation screen for performing various settings as well as displays setting information that is input. Further, the liquid crystal panel 200 reproduces or displays moving image data stored in the HDD 114, or displays a preview of still image data. If a user enters instructions using a touch panel, information about a position touched by the user is detected, and a corresponding instruction is sent to the operation unit I/F 115 through the CPU 111.

A start key 201 is a hard key to instruct the scanner 130 to start reading, or the printer 140 to start printing operation. Within the start key 201, green and red LEDs are incorporated and the green LED is turned on when the printer, scanner, or the like is ready to start operations, and the red LED is turned on when operations cannot be started due to errors or the like. A stop key 202 is a hard key to instruct the scanner 130 to stop the operation.

A hard key group 203 includes a numeric keypad, a log-in key and a user mode key. The numeric key pad is configured to input numerical values such as the number of copies. The log-in key allows a user to enter a user ID or a password to log in to a target website and the user mode key allows to shift an operational mode to a user mode to perform various types of device settings.

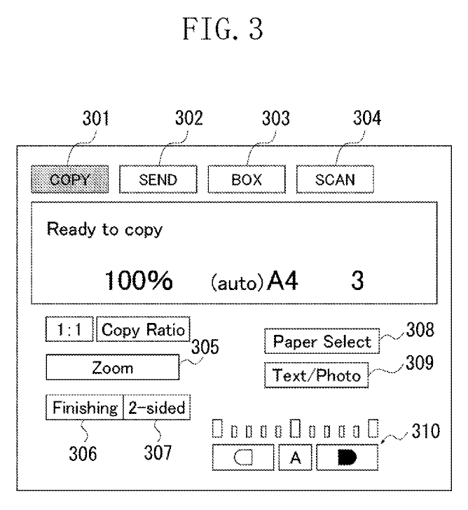

FIG. 3 shows an operation screen displayed on the liquid crystal panel 200, and shows a basic COPY screen which is displayed as a default screen when the MFP 100 is powered-on. The MFP 100 has four modes, that is, a COPY mode, a SEND mode, a BOX mode, and a SCAN mode.

In the COPY mode, copying operations are performed in which an image of the original is read by the scanner 130, the read image is input and the input image is printed by the printer 140. In the SEND mode, image data input from the scanner 130 or image data previously stored in the HDD 114 is transmitted to a destination by an e-mail or the like via the LAN 190 or the Internet. In the BOX mode, various types of data stored in a box are processed (editing, printing, sending, etc.). The box refers to a user box where storage areas on the HDD 114 are assigned to each user. In the SCAN mode, an image of the original is read by the scanner 130 and is input, and the image is stored in the box or transmitted through the LAN 190 to the host PC 170.

The above-described modes (i.e., COPY mode, SEND mode, BOX mode, and SCAN mode) can be switched by selecting an appropriate button from the mode buttons 301 to 304. In the example of FIG. 3, a screen in a case where the COPY mode is selected, is displayed. On the screen, a user performs settings of zoom in/out, selection of a sheet discharging method, double-sided/one-sided printing, selection of a sheet size, text/photograph, and density by operating the buttons 305 to 310.

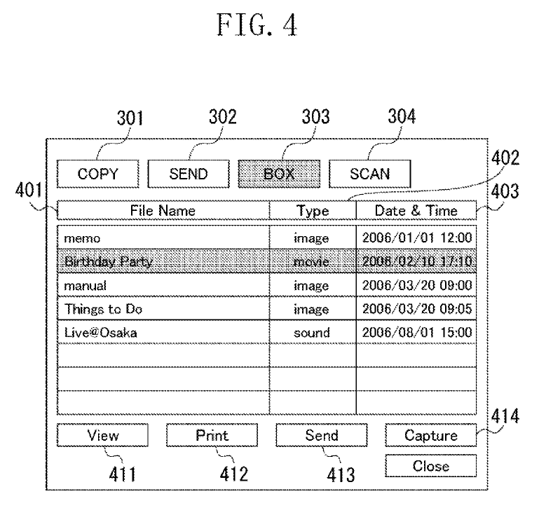

If the BOX mode button 303 is selected in FIG. 3, a user box list screen (not shown) showing a list of attribute information about user boxes assigned to each user is displayed. When any user box is selected from the user box list displayed on the user box list screen, a file list screen of FIG. 4 is displayed.

FIG. 4 shows a file list screen displaying a list of attribute information about files stored in the user box that is selected in the user box list screen. In a file name display field 401, a name of each file is displayed. In a file type display field 402, information indicating a type of each file is displayed. In the HDD 114, not only still image data (image) but also moving image data (movie) or audio data (sound) can be stored. In a storage date display field 403, information about date and time at which each file is stored in the box is displayed.

In the case where various types of processing are performed to each file stored in the user box, one of the buttons 411 to 414 is pressed while one of the displayed files is selected. Unless at least one file is selected, the buttons 411 to 414 cannot be selected. A target file can be selected by a user who touches an area where a name of the file is displayed. If the file is selected, a background color of an area which shows attribute information of the selected file, is changed to indicate that the file is selected.

In the example of FIG. 4, moving image data entitled “Birthday Party” is selected. The number of selectable files is not limited to one, but a plurality of files can be selected at a time. If a plurality of files are selected, a background color of areas which shows attribute information of each file is changed.

If the display button 411 is selected while any file is selected, contents of the selected file can be examined. More specifically, if the selected file is still image data, a preview of the image is displayed. Further, if the selected file is audio data, an audio sound is output from the speaker 160. If the selected file is moving image data, a moving image is reproduced and displayed, and an audio sound is output from the speaker 160. If a plurality of files are selected, the files are displayed and reproduced in order of selection.

If the print button 412 is pressed while any file is selected, the selected file is printed by the printer 140. However, a file that can be printed in this processing is only still image data. If the moving image data or audio data is selected, a warning message is displayed. The printing processing is described in detail later.

If the send button 413 is selected while any file is selected, the selected file is attached to an e-mail and sent to a designated address. The sending processing can be performed not only to still image data but also to moving image data or audio data. Further, if a plurality of files are selected, the files are attached to one e-mail.

### (Operation of Extracting Still Image Data)

If the capture button 414 is pressed while any file is selected, some frames are extracted and printed from the selected moving image data as still image data. A file that can be subjected to this processing is moving image data only. If the still image data or audio data is selected, a warning message is displayed. Further, this processing cannot be performed to a plurality of files at a time. If the plurality of files are selected, a warning message is displayed. In the first exemplary embodiment, a case is described as an example where still image data is extracted from moving image data entitled “Birthday Party” as shown in FIG. 4.

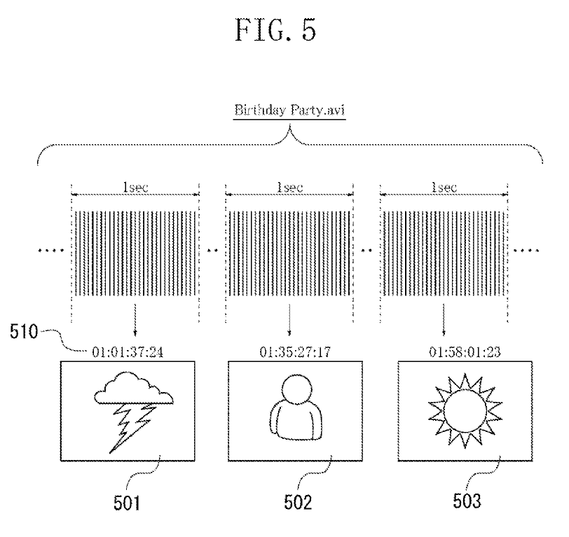

FIG. 5 schematically illustrates a structure of moving image data composed of a plurality of files. In moving image data entitled “Birthday Party.avi” (.avi is a file extension), 30 frames are switched per second (that is, a frame rate of 30), therefore, 30 frames are included in data of one second as shown in FIG. 5.

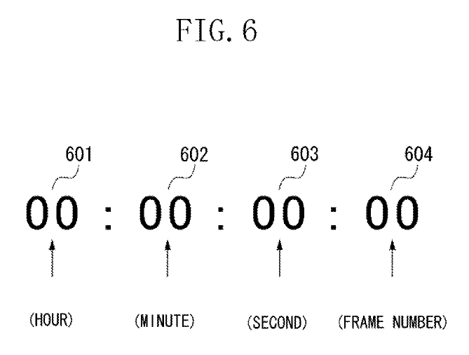

In a case where image data is replayed, time code information is added to each frame in moving image data based on the time at which each frame is reproduced. FIG. 6 is a detailed view illustrating time code information.

As shown in FIG. 6, the time code information is divided into four portions: hour (601), minute (602), second (603), and frame number (604) are illustrated in order from the left side. The frame number 604 is information indicating a frame number in each time of a second. If the frame rate of moving image data is 30, any one of 1 to 30 is displayed. For example, in the case of moving image data having the length of just 120 minutes, time code information of (00:00:01:01) is added to the first frame, and the time code information of (02:00:00:30) is added to the last frame.

Referring back to FIG. 5, “Birthday Party.avi” includes the frames 501 to 503 having the time code information 510 of (01:01:37:24),(01:35:27:17) and (01:58:01:23) respectively. The first exemplary embodiment describes the case of extracting the three frames in order of 502, 503 and 501 as still image data and storing the frames, by way of example.

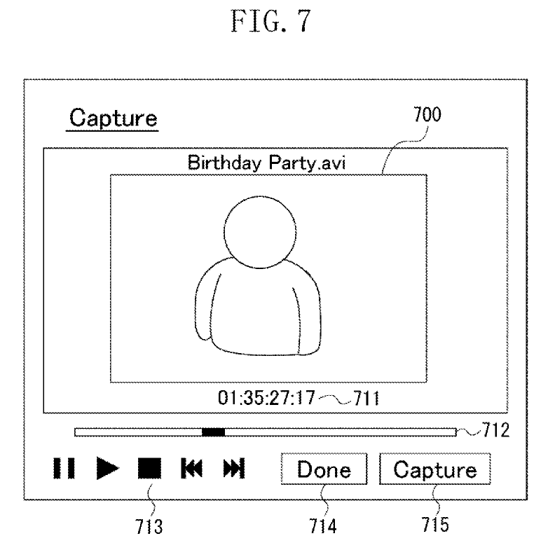

Referring back to FIG. 4, if the capture button 414 is selected while “Birthday Party” is selected, the capture instructing screen of FIG. 7 is displayed. In FIG. 7, in a moving image data display area 700, images of each frame in the moving image data are displayed. In a time code information display area 711, time code information corresponding to the frame displayed in the moving image data display area 700 is displayed. A seek bar 712 indicates a location of a frame displayed in the moving image data display area 700, relative to the entire moving image data.

A user selects each button from the button group 713 to instruct playback, stop, fast-forward, fast-reverse, and frame advance to retrieve an image of a frame to be printed. To select a frame that is to be extracted and printed as still image data, reproduction of moving image data is stopped while a desired frame is displayed in the moving image data display area 700, and a capture button 715 is pressed.

When the capture button 715 is pressed, the currently displayed frame is extracted as still image data and stored in the same user box as that which stores the moving image data. At this time, a file name of the new still image data is determined based on time code information corresponding to the extracted frame. That is, in the example of FIG. 7, when the capture button 715 is pressed, still image data having a file name of “01352717.jpg” is generated. In this example, the still image data is generated in the JPEG format, therefore, an extension “.jpg” is added. However, a format of image data is not limited to the JPEG format.

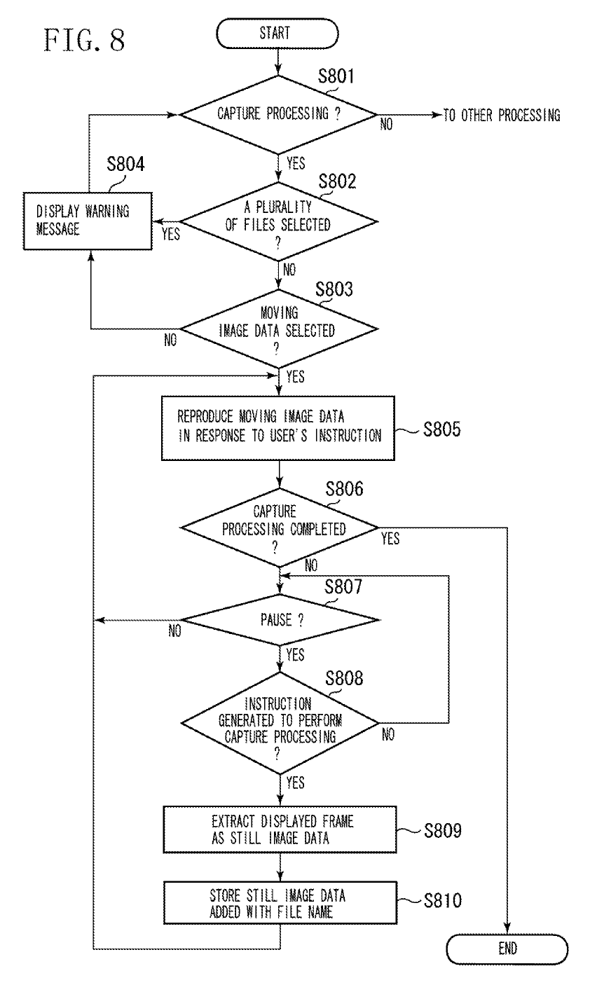

FIG. 8 is a flowchart illustrating a series of processing for extracting a frame included in the moving image data as a still image data. The series of processing in the flowchart are controlled by the CPU 111 of the control unit 110 in accordance with programs stored in the HDD 114.

First, in step S801, it is determined whether a capture processing is instructed by a user. More specifically, if the capture button 414 of FIG. 4 is selected, the processing advances to step S802. If other buttons are selected, a corresponding processing is performed.

In step S802, it is determined whether a plurality of files are selected in the screen of FIG. 4. If it is determined that only one file is selected, the processing advances to a subsequent step S803 to determine whether the selected file is moving image data. If the selected file is moving image data, then the processing advances to step S805.

If it is determined that the plurality of files are selected in step S802 or a file other than the moving image data is selected in step S803, the processing advances to step S804 to display a warning message and then returns to step S801.

In step S805, selected moving image data is displayed by performing playback, stop, pause, fast-forward, fast-reverse, or frame-advance in accordance with instructions of a user using the button group 713. In a subsequent step S806, it is determined whether an instruction to end capture processing is sent from a user. More specifically, if it is detected that a done button 714 of FIG. 7 is pressed, it is determined that a user sends an instruction to end the capture processing, and the capture processing ends. On the otherhand, if a user does not send an instruction to end the capture processing, the processing advances to step S807.

In step S807, it is determined whether a user has sent an instruction to pause playback of moving image data. The pause refers to a state where a particular frame is displayed and paused without further reproduction. If a predetermined time has elapsed while capture processing which is described later, is not instructed, the pause is automatically cancelled.

In step S807, if it is determined that the pause is instructed by a user, the processing advances to step S808 to determine whether a user sends an instruction to perform capturing processing. More specifically, if the capture button 715 is pressed in the screen of FIG. 7, it is determined that a user sends an instruction to perform capturing processing, and the processing advances to step S809. If the user does not send an instruction to perform the capturing processing, the processing returns to step S807 and waits for a user to press the capture button 715.

In step S808, if it is determined that a user has sent an instruction to perform capturing processing, the processing advances to step S809. In step S809, an image of a displayed frame is clipped as still image data. In a subsequent step S810, a file name generated based on time code information corresponding to the clipped frame is added to the extracted still image data and the data is stored. After that, the processing returns to step S805 to restart reproduction of moving image data.

Further, a user can also select a frame to be extracted as still image data by a method other than the above-described method in which a frame is selected while reproducing the moving image data. For example, a user can directly input time code information and extract a frame corresponding to the input time code information as still image data. Furthermore, any other methods can also be used as long as a frame in the moving image data can be selected.

### (Printing of Extracted Still Image Data)

Next, print processing is described in which a file obtained by extracting a frame included in moving image data as still image data and stored is printed by the above method.

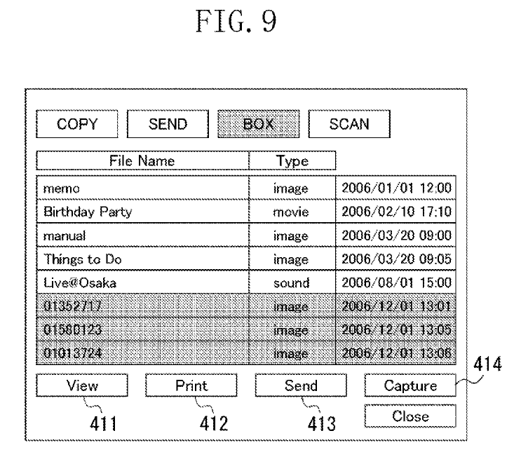

A screen of FIG. 9 is another example of the file list screen of FIG. 4. In comparison with the example of FIG. 4, three still image data are additionally stored. As described above, in the first embodiment, as an example, three frames of FIG. 5 are extracted as still image data in the frame order of 502, 503, and 501.

The still image data extracted from the frames 502, 503, and 501 are given file names based on time code information of the respective frames, i.e., “01352717”, “01580123”, and “01013724”, and listed in the order in which the still images are extracted.

Here, a case is described where these three files are collectively printed. As described above, a file displayed on the file list is selected, and the print button 412 is selected to print out still image data saved in a user box with the printer 140. If a plurality of files are selected at this time, the print button 412 is pressed to instruct the printer to collectively print these files.

In the case where the plurality of files are designated and collectively printed in accordance with one printing instruction, the files are generally printed in the order in which the files are selected. In the example of FIG. 9, the three files are selected from the list. For example, if the files are selected in the order of “01352717”, “01580123”, and “01013724”, the files are printed out in the stated order.

However, the above-described order differs from the order in which the extracted frames are reproduced in the moving image data “Birthday Party”. When only three files are collectively printed as in the above-described example, a user can manually rearrange the files after printing. However, in the case where still image data is extracted from long moving image data or a large number of still images are extracted, a user needs to perform a troublesome task.

Therefore, according to the first embodiment, a mode is provided in which frames of moving image data are automatically rearranged and printed out when a plurality of still image data extracted from frames of the moving image data is collectively printed. As a result, a user can print the extracted still image data in the order in which the still image data of each frame in the moving image data is reproduced without the troublesome processing.

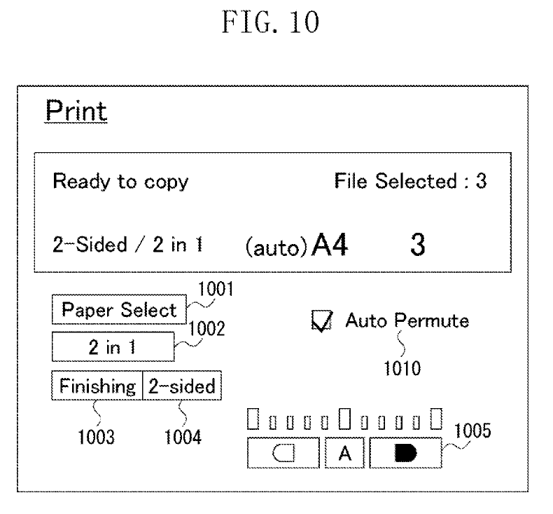

More specifically, a printing condition setting screen illustrated in FIG. 10 is displayed when the print button 412 is pressed while a plurality of files is selected as shown in FIG. 9. FIG. 10 illustrates an operating screen for setting printing conditions to print a file stored in the user box. The user sets printing conditions such as printing paper, N-in-1 layout, a sheet delivery method, two-sided or one-sided printing, and density by operating buttons 1001 to 1005 on the screen.

Further, the user can determine whether to auto-permute images with a checkbox 1010. If the user instructs auto-permutation, a plurality of files selected on the file list screen of FIG. 9 are automatically permuted and printed in accordance with a file name. As a result, the plurality of selected files are printed in the order of reproduction of the original moving image data. On the other hand, if the checkbox 1010 of Auto Permute is not marked, the files are printed in the order in which the files are selected on the file list screen of FIG. 9 as usual.

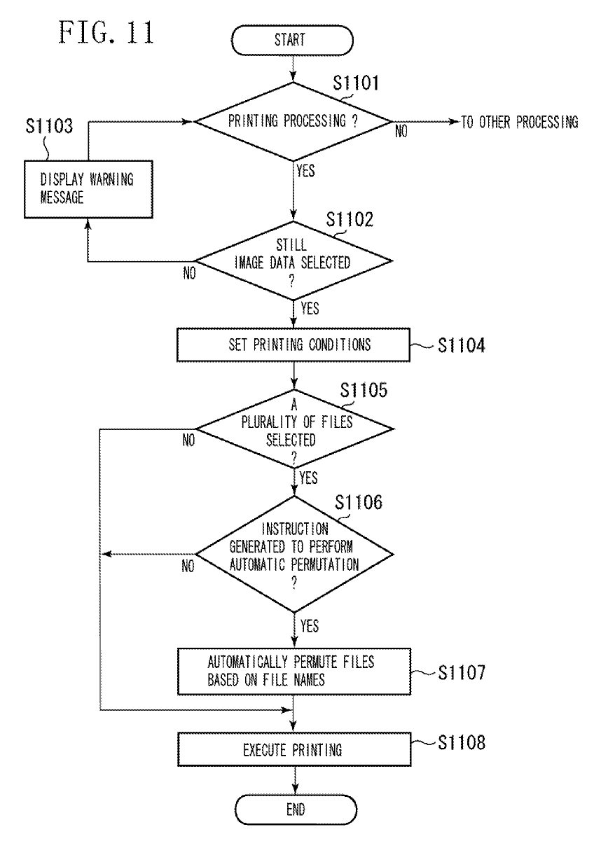

FIG. 11 is a flowchart illustrating a series of processing for automatically rearranging still images in the order of each frame in moving image data and printing the rearranged still images when the plurality of still image data extracted from the moving image data is printed. The series of processing in the flowchart are controlled by the CPU 111 of the control unit 110 in accordance with programs stored in the HDD 114.

First, in step S1101, it is determined whether a user has sent an instruction to perform printing processing. More specifically, if the print button 412 of FIG. 9 is pressed, the processing advances to step S1102. If the other buttons are selected, a corresponding processing is performed.

In step S1102, it is determined whether the selected file is still image data. If it is determined in step S1102 that the selected file is still imaged data, the processing advances to step S1104. If it is determined in step S1102 that the selected file is not still image data, the processing advances to step S1103. In step S1103, a warning message is displayed, then, the processing returns to step S1101. When the plurality of files are selected in step S1102, the processing advances to step S1103 if at least one file that is not still image data is detected.

In step S1104, printing conditions for printing selected files are set in accordance with a user instruction sent by operating the buttons 1001 to 1005. In a subsequent step S1105, it is determined whether a plurality of files are selected on the screen of FIG. 9. If only one file is selected in step S1105, the processing advances to step S1108.

On the other hand, if it is determined in step S1105 that the plurality of files is selected, the processing advances to step S1106. In step S1106, it is determined whether an instruction to auto-permute files is sent. More specifically, it is determined whether the checkbox 1010 is marked in the printing condition setting screen of FIG. 10. If the checkbox 1010 is marked, it is determined that a user has sent an instruction to print the plurality of selected files in the order of reproduction of the original moving image data. Then, the processing advances to step S1107. On the other hand, if the checkbox 1010 is not marked, the processing advances to step S1108.

In step S1107, the plurality of files designated as a printout target in the screen of FIG. 9 are automatically rearranged in the ascending order in accordance with a file name. Then, the processing advances to step S1108. In step S1108, the files to be printed are expanded in the order in which the files are read from the HDD 114, and printed out by the printer 140.

As described above, according to the first embodiment, when frames in moving image data are extracted as still image data, a file name based on time code information corresponding to the extracted frames is added to still image data, and the still image data is stored. Then, at the time of collectively printing the plurality of still image data thus stored, the files are automatically rearranged in the order of reproduction in the original moving image data in accordance with a user instruction, and then printed out.

Thus, when the plurality of still image data extracted from the moving image data is collectively printed, a user can easily rearrange the images in the order of reproduction of the original moving image data without performing a troublesome processing. Further, the still image data extracted from moving image data is given a file name based on time code information of a corresponding file. Accordingly, a user can visually and easily check a location or reproduction time of each still image data in the original moving image data.

### Second Exemplary Embodiment

Next, a second exemplary embodiment of the present invention is described. The second exemplary embodiment differs from the first exemplary embodiment in that, when still image data is extracted from moving image data, the above time code information is added as attribute information instead of the file name. Further, in addition to the time code information, a file name of moving image data for identifying the original moving image is also added as attribute information. The basic configuration of the second exemplary embodiment is the same as that of the first exemplary embodiment, therefore, detailed description will be omitted. The following description is focused on the difference between the first exemplary embodiment and the second exemplary embodiment.

The processing of extracting still image data from moving image data according to the second exemplary embodiment is performed in accordance with the flowchart according to the first exemplary embodiment of FIG. 8. However, in the second exemplary embodiment, the file name is not added as is performed in step S810 of FIG. 8. Instead, the time code information is added to the extracted still image data as attribute information.

In the first exemplary embodiment, the time code information is added as a file name of still image data. However, if the file name is changed by user operations in this case, auto-permute processing of step S1107 in FIG. 11 cannot be correctly performed. That is, when a plurality of still image data is collectively printed, a user cannot change a file name if the images have to be automatically rearranged and printed in the order of reproduction of the original moving image data. Thus, usability becomes low. To address that problem, according to the second exemplary embodiment, the time code information is added to the extracted still image data as attribute information instead of the file name.

Further, in the second exemplary embodiment, in step S810 of FIG. 8, the file name of the moving image data is added as attribute information in addition to the time code information to enable identifying of the original moving image data. This is because, when a plurality of moving image data can be stored, for example, in the MFP 100, if the still image data extracted from each moving image data is rearranged based on the time code information alone, there is a possibility that still image data extracted from different moving image data is mixed.

Accordingly, in the second exemplary embodiment, information that identifies moving image data is added as attribute information in addition to the time code information to rearrange still image data based on moving image data so that the still image data can be distinguished according to each moving image.

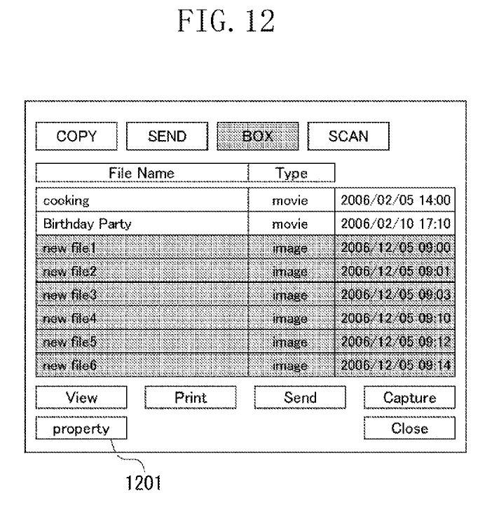

FIG. 12 illustrates a file list screen corresponding to the screen of FIG. 9 described in the first exemplary embodiment. It is assumed here that still image data “new file 1” to “new rile 6” are extracted and stored from moving image data with a file name of “cooking” or “Birthday Party” previously stored in a user box. The extracted still image data are given a file name including a common portion “new file” that is previously set and a serial number added to each still image in the order in which the images are extracted.

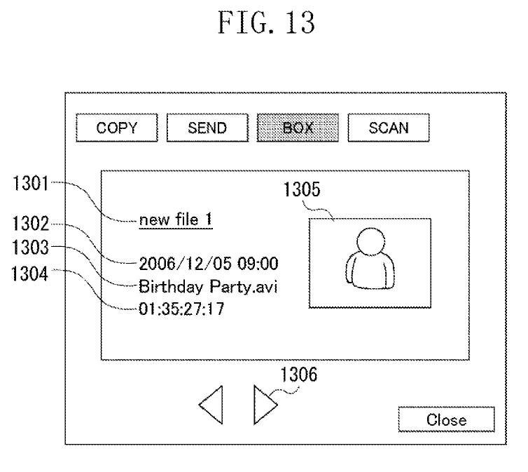

In FIG. 12, a property button 1201 that is not displayed on the screen of FIG. 9 is displayed. The property button is selected to check attribute information of a file selected from the file list. FIG. 13 illustrates an example of the property display screen which is displayed when the property button 1201 is pressed while the six still image data “new file 1” to “new rile 6” are selected as shown in FIG. 12.

On the property display screen of FIG. 13, attribute information of each item are displayed using display areas 1301 to 1305. A file name is displayed in the display area 1301. Information representing data and time when the image is extracted from the moving image data is displayed in the display area 1302. A file name of the original moving image data from which the still image data is extracted is displayed in the display area 1303. Time code information corresponding to a frame extracted as still image data is displayed in the display area 1304. A preview of the still image data is displayed in the display area 1305.

If the property button 1201 is pressed while the plurality of files is selected, a scroll key 1306 is displayed on the property display screen. If the scroll key 1306 is selected, a screen is switched to display attribute information of another file. In addition, it is possible to prohibit a user from editing the attribute information. As a result, it is possible to prove when and from which moving image data the still image data is extracted based on the attribute information.

Next, printing processing of the second exemplary embodiment is described. The printing processing of the still image data according to the second exemplary embodiment is performed in accordance with a flowchart of FIG. 11 similar to the first exemplary embodiment. However, in the second exemplary embodiment, the images are rearranged based on attribute information added to the still image data instead of rearranging the images in accordance with a file name as performed in step S1107 of FIG. 11.

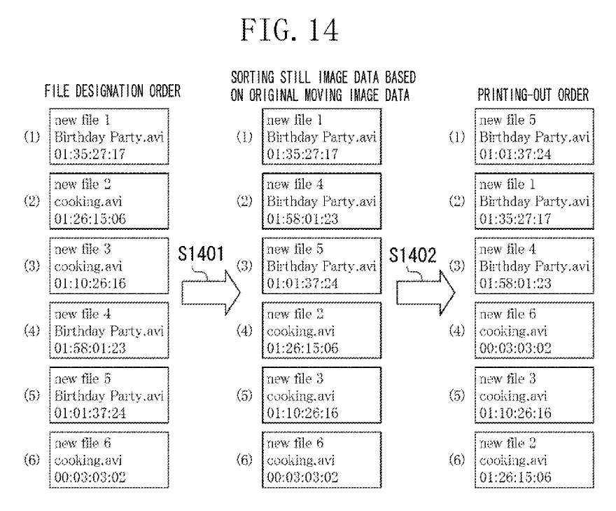

More specifically, in step S1107 of FIG. 11, the images are rearranged based on the file name of the original moving image data that is added to each still image data as attribute information and time code information. FIG. 14 is a conceptual view that illustrates rearranging processing of the second exemplary embodiment.

First, if a plurality of still image data are selected for printing, the still image data are printed out in the order in which a user selects the image data. Here, if a user instructs an auto-permute processing, first, still image data is sorted based on each moving image data in step S1401. More specifically, the still image data is sorted in accordance with a file name of moving image data added as attribute information.

Further, in a subsequent step S1402, still image data is rearranged based on time code information with respect to each moving image data. That is, in the example of FIG. 14, still image data “new file 1”, “new file 4”, and “new file 5” extracted from “Birthday Party.avi” are grouped distinguished from the other still image data. Then, only these still image data extracted from “Birthday Party.avi” are rearranged in accordance with the time code information.

As a result, the still image data are printed while grouped based on each original moving image data, in the order of reproduction in each moving image data. If printed sheets having each still image data are collectively stapled or discharged based on each original moving image data, usability is improved.

As described above, in the second exemplary embodiment, time code information of a frame extracted as still image data and a file name of the original moving image data are added to still image data as attribute information. Then, when the images are printed, the images are grouped based on each original moving image data and rearranged in accordance with the time code information. Accordingly, the images can be appropriately rearranged even when a plurality of the still image data extracted from plural different moving image data is collectively printed.

In the first and second exemplary embodiments, time code information is used as information indicating a location of each frame in moving image data. However, any other information that represents a sequence of frames can be used. For example, information of serial numbers added to all frames in the moving image data can also be used.

In the exemplary embodiments, the case of printing processing is described. However, aside from the printing processing, the auto-permute processing according to the exemplary embodiments, can be applied to any other cases where a plurality of still image data is collectively selected and processed.

### Other Exemplary Embodiment

The above is detailed description about the exemplary embodiments. The present invention allows embodiments as a system, an apparatus, a method, a program, or a storage medium (recording medium). More specifically, the present invention is applicable to a system configured by a plurality of devices, or an apparatus composed of one device.

According to the present invention, software programs for executing the above functions of the exemplary embodiments (programs corresponding to the flowcharts in the exemplary embodiments) can be directly or remotely supplied to a system or an apparatus. Therefore, the scope of the present invention encompasses the thus supplied program code which is read and executed by a computer of the system or apparatus.

That is, the scope of the present invention includes a computer program itself for realizing the functional processing of the present invention.

In this case, as long as a program function is included, the other forms such as an object code, a program executed by an interpreter, and script data supplied to an OS can be used.

A recording medium for supplying a program includes a floppy disk, a hard disk, an optical disk, a magneto optical disk, a MO, a CD-ROM, a CD-R, a CD-RW, a magnetic tape, a nonvolatile memory card, a ROM, and a DVD (DVD-ROM, DVD-R)

Besides, as a method of supplying a program, a program can be supplied by downloading the program from an Internet website to a recording medium such as a hard disk using a browser of a client computer. That is, the website is accessed to download a computer program itself of the present invention or a compressed file including an automatic installing function from the website. Further, program codes constituting a program of the present invention are divided into a plurality of files, and the files are downloaded from different websites. That is, a WWW server for downloading to a plurality of users program files that causes a computer to perform functional processing of the present invention, is encompassed in the scope of the present invention.

Further, a program of the present invention can be encoded and stored in a storage medium such as a CD-ROM, and transferred to users. Then, a user who satisfies a predetermined condition is allowed to download key information for decoding the program through the Internet from the website. Then, the encoded program can be executed using the key information and installed to the computer to perform the processing.

Further, the computer executes a read program to perform the above functions of the exemplary embodiment. In addition, an OS running on the computer performs a part or all of the actual processing in accordance with an instruction of the program, and the functions of the exemplary embodiments can be performed through this processing.

Further, the functions of the exemplary embodiments are realized when a program read from the recording medium is written to a memory including an expansion board inserted to a commuter or an expansion unit connected to the computer. That is, the functions of the exemplary embodiments are realized by a CPU in the expansion board or expansion unit executing a part or all of the actual processing in accordance with an instruction of the program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-343047 filed Dec. 20, 2006, which is hereby incorporated by reference herein in its entirety.

What is claimed is:

1. An image processing apparatus comprising:
an input unit configured to input moving image data that includes a plurality of frames;
a first selecting unit configured to select a frame from the plurality of frames included in the input moving image data;
an extraction unit configured to extract the frame selected by the first selection unit from the moving image data as still image data;
an adding unit configured to add location information to the extracted still image data as attribute information, the location information indicating a location of the selected frame in the moving image data;
a memory unit configured to store the extracted still image data to which the location information is added;
a second selecting unit configured to select a plurality of still image data stored in the memory unit; and
a printing unit configured to print the plurality of still image data selected by the second selecting unit according to an order determined based on the location information.

2. The image processing apparatus according to claim 1, wherein the adding unit adds the location information to the extracted still image data as a file name of the still image data.

3. The image processing apparatus according to claim 1, wherein the adding unit adds time-code information, that indicates a location of each frame in the moving image data, as the location information.

4. The image processing apparatus according to claim 1, wherein the adding unit further adds identification information to the extracted still image data as attribute information, the identification information indicating the moving image data from which the still image data is extracted, and the printing unit is configured to print the plurality of still image data selected by the second selecting unit according to an order determined based on the location information and the identification information.

5. The image processing apparatus according to claim 4, wherein the printing unit collectively prints the still image data to which the same identification information is added.

6. The image processing apparatus according to claim 1, further comprising a designating unit configured to designate a first printing mode or a second printing mode;
wherein the printing unit prints the plurality of still image data selected by the second selecting unit according to an order determined based on the location information in a case where the first printing mode is designated by the designating unit, and prints the plurality of still image data selected by the second selecting unit according to an selected order in a case where the second printing mode is designated by the designating unit.

7. A method comprising:
inputting moving image data that includes a plurality of frames;
selecting a frame from the plurality of frames included in the input moving image data;
extracting the selected frame from the moving image data as still image data;
adding location information to the extracted still image data as attribute information, the location information indicating a location of the selected frame in the moving image data;
storing in a memory unit the extracted still image data to which the location information is added;
selecting a plurality of still image data stored in the memory unit; and
printing the plurality of the selected still image data according to an order determined based on the location information.

8. The method according to claim 7, wherein the location information is added to the extracted still image data as a file name of the still image data.

9. The method according to claim 7, wherein time-code information, that indicates a location of each frames in a moving image data, is added as the location information.

10. The method according to claim 7, wherein identification information is further added to the extracted still image data as attribute information, the identification information indicating the moving image data from which the still image data is extracted, and the plurality of still image data selected are printed according to an order determined based on the location information and the identification information.

11. The method according to claim 10, wherein the still image data to which the same identification information is added are collectively printed.

12. The method according to claim 7, wherein the plurality of selected still image data are printed according to an order determined based on the location information in a case where the first printing mode is designated, and the plurality of selected still image data are printed according to an selected order in a case where the second printing mode is designated.

13. A computer-readable storage medium storing instructions which, when executed by an apparatus, causes the apparatus to perform operations comprising:
selecting a frame from a plurality of frames included in moving image data;
extracting the selected frame from the moving image data as still image data;
adding location information to the extracted still image data as attribute information, the location information indicating a location of the selected frame in the moving image data;
storing in a memory unit the extracted still image data to which the location information is added;
selecting a plurality of still image data stored in the memory unit; and
printing the plurality of the selected still image data according to an order determined based on the location information.

14. The computer-readable storage medium according to claim 13, wherein the apparatus executing the stored instructions comprises a multi-function peripheral (MFP).
